(19) United States
(12) Patent Application Publication
(10) Pub. No.: US 2025/0278841 A1
(43) Pub. Date: Sep. 4, 2025

(54) INSPECTION APPARATUS AND INSPECTION METHOD

(71) Applicant: NuFlare Technology, Inc., Yokohama-shi (JP)

(72) Inventor: Shinji SUGIHARA, Tokyo (JP)

(73) Assignee: NuFlare Technology, Inc., Yokohama-shi (JP)

(21) Appl. No.: 19/202,155

(22) Filed: May 8, 2025

Related U.S. Application Data
(63) Continuation of application No. PCT/JP2023/035469, filed on Sep. 28, 2023.

(30) Foreign Application Priority Data
Dec. 27, 2022 (JP) 2022-210563

(51) Int. Cl. G06T 7/13; G06T 7/00; G06T 7/136

(52) U.S. Cl. CPC G06T 7/13; G06T 7/001; G06T 7/136; G06T 2207/10061; G06T 2207/30148

(57) ABSTRACT

According to an embodiment, an inspection apparatus includes an image capturing mechanism configured to capture a first image of a wafer or a mask, a first circuit configured to calculate a first threshold based on a plurality of gradation values of the first image, a second circuit configured to generate a first line based on a predetermined function using the first threshold in a second pixel provided in a matrix of n×m first pixels with n rows and m columns included in the first image, where n and m are integers of two or greater, a third circuit configured to calculate a first point in the second pixel by using the first line, and a comparison circuit configured to compare a reference image with an inspection image that is based on the first point.

### CROSS-REFERENCE TO RELATED APPLICATION

This application is a Continuation Application of PCT Application No. PCT/JP2023/035469, filed Sep. 28, 2023, and based upon and claiming the benefit of priority from Japanese Patent Application No. 2022-210563, filed Dec. 27, 2022, the entire contents of all of which are incorporated herein by reference.

### FIELD

The present invention relates generally to an inspection apparatus and an inspection method for inspecting a defect in a pattern formed on a sample.

### BACKGROUND

In a semiconductor device manufacturing process, a circuit pattern is transferred onto a semiconductor substrate by means of reduction exposure with an exposure apparatus (also referred to as a “stepper” or a “scanner”). In the exposure apparatus, a mask (also referred to as a “reticle”) on which an original pattern is formed is used to transfer a circuit pattern onto a semiconductor substrate (also referred to as a “wafer” hereinafter).

In the most-advanced devices, it is required, for example, to form a circuit pattern with a line width of several nanometers. With the miniaturization of the circuit pattern, original image patterns in the mask are also miniaturized. Therefore, an electron-beam defect inspection apparatus is required to achieve high defect-detection performance compliant with the miniaturized patterns.

There are modes of defect inspection including a die to database (D-DB) mode in which an inspection image based on an image (a captured image) obtained by capturing an image of a sample (a mask, wafer, etc.) is compared with a reference image based on design data, and a die to die (D-D) mode in which images in a plurality of regions having the same pattern formed on a sample are compared to one another.

The electron-beam defect inspection apparatus extracts a contour line of a pattern from a captured image to generate an inspection image. The electron-beam defect inspection apparatus detects a defect by comparing a contour line of the pattern of the inspection image with that of the pattern of the reference image.

For example, Jpn. Pat. Appln. KOKAI Publication No. 2022-16779 discloses a method of extracting a contour line from a captured image using a plurality of two-dimensional spatial filter functions having different directivities. In this case, a filtering process is performed for each of the different directions in each frame image (pixel). If at least one of the values (post-filter intensities) obtained for the respective directions is larger than a threshold value, the pixel is extracted as a candidate for a pixel including a contour line (contour pixel candidate).

Jpn. Pat. Appln. KOKAI Publication No. 2020-183928 discloses, for example, a method in which a brightness value of a given rectangular region is interpolated for each of an inspection image and a reference image, and an area of a region whose interpolated brightness value is greater than the reference brightness value is computed. Thereafter, the area of the inspection image and the area of the reference image are compared. In this case, a deviation between the inspection image and the reference image is inspected based on a difference in area in the rectangular region.

In an electron-beam defect inspection apparatus, a decrease in an edge intensity of a pattern of a captured image leads to a gentle edge profile of the captured image, making it difficult to stably extract a contour line of the pattern from the captured image. Moreover, with advancement in pattern miniaturization, if the edge-to-edge distance of the pattern becomes smaller than the size of the edge filter, it is difficult to extract a contour line. Decreasing a length of the edge filter to address such an issue results in a decrease in the noise resistance and the positional precision.

### SUMMARY

The present invention has been made in view of the above-described circumstances. That is, it is possible in the present invention, in capturing an SEM image, to obtain a large signal-to-signal difference (referred to as a “rich material contrast” hereinafter) at segments at which secondary electrons are emitted with varying intensities according to the type of the material of the irradiation surface, namely, edge segments of the pattern by irradiating a sample with an electron beam, and to extract a contour line of a pattern even in the case of there being a small edge intensity. It is therefore an object to provide an inspection apparatus and an inspection method capable of improving accuracy of extraction of a contour line.

According to a first aspect of the present invention, an inspection apparatus includes an image capturing mechanism configured to capture a first image of a wafer or a mask, a first circuit configured to calculate a first threshold based on a plurality of gradation values of the first image, a second circuit configured to generate a first line based on a predetermined function using first threshold in a second pixel provided in a matrix of n×m first pixels with n rows and m columns included in the first image, where n and m are integers of two or greater, a third circuit configured to calculate a first point in the second pixel by using the first line, and a comparison circuit configured to compare a reference image with an inspection image that is based on the first point.

According to a second aspect of the present invention, an inspection apparatus includes capturing a first image of a wafer or a mask, calculating a first threshold based on a plurality of gradation values of the first image, generating a first line based on a predetermined function using the first threshold in a second pixel provided in a matrix of n×m first pixels with n rows and m columns included in the first image, where n and m are integers of two or greater, calculating a first point in the second pixel by using the first line, and comparing a reference image with an inspection image that is based on the first point.

### BRIEF DESCRIPTION OF THE DRAWINGS

FIG. 1 is a diagram showing an overall configuration of an inspection apparatus according to a first embodiment.

FIG. 2 is a block diagram of a contour extraction circuit included in the inspection apparatus according to the first embodiment.

FIG. 3 is a flowchart of an inspection process in an inspection apparatus according to the first embodiment.

FIG. 4 shows a specific example of 4×4 pixels including a contour line of an inspection image and a contour line of a reference image in a comparison step in the inspection apparatus according to the first embodiment.

FIG. 5 is a flowchart for generating an area image and generating contour data in the inspection apparatus according to the first embodiment.

FIG. 6 is a specific example of a histogram showing a relationship between the gradation value and the number of pixels of an SEM image in the inspection apparatus according to the first embodiment.

FIG. 7 is a diagram showing a specific example of calculating an area of an area pixel in the inspection apparatus according to the first embodiment.

FIG. 8 is a diagram showing a relationship between an SEM image and an area image in the inspection apparatus according to the first embodiment.

FIG. 9 is a diagram showing a specific example of a first filtering process in the inspection apparatus according to the first embodiment.

FIG. 10 is a diagram showing a specific example of a second filtering process in the inspection apparatus according to the first embodiment.

FIG. 11 is a diagram showing a specific example of calculating contour points in the inspection apparatus according to the first embodiment.

FIG. 12 is a diagram showing a specific example of an area image in the inspection apparatus according to the first embodiment.

FIG. 13 is a diagram showing a specific example of a proximity contour point in the inspection apparatus according to the first embodiment.

FIG. 14 is a diagram showing a specific example of an inspection image in the inspection apparatus according to the first embodiment.

FIG. 15 is a flowchart for generating an area image and generating contour data in an inspection apparatus according to a second embodiment.

FIG. 16 is a diagram showing a specific example of calculating contour points in the inspection apparatus according to the second embodiment.

FIG. 17 is a flowchart of an inspection process in an inspection apparatus according to a third embodiment.

FIG. 18 is a flowchart for generating an area image and generating contour data in the inspection apparatus according to the third embodiment.

FIG. 19 is a diagram showing an example in which each of an inspection SEM image and a reference SEM image is divided into four regions in the inspection apparatus according to the third embodiment.

FIG. 20 is a flowchart for generating an area image and generating contour data in an inspection apparatus according to a fourth embodiment.

### DETAILED DESCRIPTION

Hereinafter, embodiments will be described with reference to the drawings. Each embodiment illustrates an apparatus and/or a method for embodying the technical idea of the invention. The drawings are either schematic or conceptual, and the dimensions, ratios, etc. of each drawing are not necessarily identical to the actual ones. The technical idea of the present invention is not designated by the shape, structure, arrangement, etc. of the components.

Hereinafter, a defect inspection apparatus configured to capture an electron beam image (also referred to as an “SEM image” hereinafter) of a sample with a scanning electron microscope (referred to as an SEM hereinafter) will be described. Note that the defect inspection apparatus may capture an image by irradiating a sample with an energy beam other than an electron beam. Note that the defect inspection apparatus may capture an optical image of a sample using an optical microscope or may capture an optical image of light reflected by or transmitted through a sample using a light-receiving element. The embodiment is directed to a case where a sample to be inspected is a mask; however, the sample may be a wafer for use in manufacturing a semiconductor device, a substrate for use in a liquid crystal display device, or the like as long as a pattern is provided on the surface of the sample.

### 1. First Embodiment

A first embodiment will be described. In the first embodiment, a case will be described where a die-to-database (D-DB) inspection mode is adopted as the defect inspection mode.

### 1.1. Overall Configuration of Inspection Apparatus

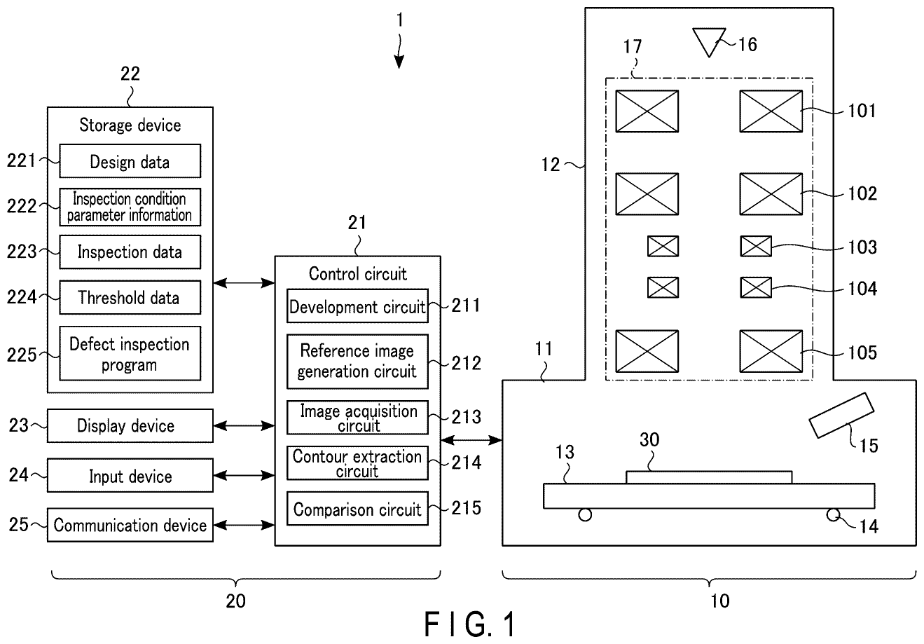

First, an example of an overall configuration of an inspection apparatus will be described with reference to FIG. 1. FIG. 1 is a diagram showing an overall configuration of an inspection apparatus 1.

As shown in FIG. 1, the inspection apparatus 1 includes an image capturing mechanism 10 and a control mechanism 20.

The image capturing mechanism 10 includes a sample chamber 11 and a lens barrel 12. The lens barrel 12 is set on the sample chamber 11. The lens barrel 12 has, for example, a cylindrical shape extending perpendicularly to the sample chamber 11. The sample chamber 11 and the lens barrel 12 are open on their mutually contacting surfaces. The space formed by the sample chamber 11 and the lens barrel 12 is maintained in a vacuum (low-pressure) state using a turbo molecular pump or the like.

In the sample chamber 11, a stage 13, a stage driving mechanism 14, and a detector 15 are provided.

A sample (mask) 30 is placed on the stage 13. The stage 13 is movable in the X direction parallel to the surface of the stage 13 and in the Y direction parallel to the surface of the stage 13 and intersecting the X direction. The stage 13 may also be movable in the Z direction perpendicular to the surface of the stage 13, or may be rotatable about the rotation axis on the XY plane with the Z direction as the rotation axis.

The stage driving mechanism 14 has a driving mechanism for moving the stage 13 in the X and Y directions. Note that the stage driving mechanism 14 may include, for example, a mechanism that moves the stage 13 in the Z direction or a mechanism that rotates the stage 13 around the rotation axis on the XY plane with the Z direction as the rotation axis.

The detector 15 detects secondary electrons or reflected electrons emitted from the sample. The detector 15 transmits the detected signals such as secondary electrons or reflected electrons, that is, data of the captured SEM image, to an image acquisition circuit 213.

In the lens barrel 12, an electron gun 16 and an electron optical system 17, which are components of the SEM, are provided. In the example of FIG. 1, a configuration of an electron optical system 17 configured to irradiate a sample 30 with a single beam is shown. Note that the electron optical system 17 may be configured to irradiate the sample 30 with multiple beams.

The electron gun 16 is set so as to emit an electron beam toward the sample chamber 11. The electron beam emitted by the electron gun 16 may be either a single beam or multiple beams.

The electron optical system 17 irradiates the sample 30 by focusing the electron beam emitted from the electron gun 16 to a predetermined position of the sample 30. For example, the electron optical system 17 includes a plurality of focusing lenses 101 and 102, a plurality of scanning coils 103 and 104, and an objective lens 105. The electron beam emitted from the electron gun 16 is accelerated and then focused onto the surface of the sample 30 placed on the stage 13 as an electron spot through the focusing lenses 101 and 102 and the objective lens 105. The scanning coils 103 and 104 control the position of the electron spot on the sample 30.

The control mechanism 20 includes a control circuit 21, a storage device 22, a display device 23, an input device 24, and a communication device 25.

The control circuit 21 controls the entire inspection apparatus 1. More specifically, the control circuit 21 controls the image capturing mechanism 10 to capture an SEM image (captured image). The control circuit 21 also controls the control mechanism 20 to compare an inspection image with a reference image and detect a defect. That is, the control circuit 21 is a processor configured to execute defect inspection. The control circuit 21 includes, for example, a central processing unit (CPU), a random-access memory (RAM), and a read-only memory (ROM), which are not shown. For example, the CPU loads a program, which is stored in the storage device 22 or a ROM as a non-transitory storage medium, into the RAM. Thereafter, the control circuit 21 causes the CPU to interpret and execute the program loaded on the RAM to control the inspection apparatus 1. Note that the control circuit 21 may be, for example, a CPU device such as a microprocessor, a computer device such as a personal computer, or the like. The control circuit 21 may include a dedicated circuit (a dedicated processor) in which at least some of the functions are performed by other integrated circuits such as an application-specific integrated circuit (ASIC), a field-programmable gate array (FPGA), or a graphics processing unit (GPU).

The control circuit 21 includes a development circuit 211, a reference image generation circuit 212, an image acquisition circuit 213, a contour extraction circuit 214, and a comparison circuit 215. These circuits may be configured by programs executed by a control circuit 21, may be configured by hardware or firmware provided in the control circuit 21, or may be configured by individual circuits controlled by the control circuit 21. Hereinafter, a case will be described where the control circuit 21 executes the programs to implement the functions of the development circuit 211, the reference image generation circuit 212, the image acquisition circuit 213, the contour extraction circuit 214, and the comparison circuit 215.

For example, the development circuit 211 develops design data 221 stored in the storage device 22 into data for each pattern (figure) to interpret a figure code, a figure dimension, and the like indicating a figure shape of the figure data. Then, the development circuit 211 develops the design data into a binary or multivalued (e.g., 8-bit) image (also referred to as a “developed image” hereinafter) as a pattern formed in a grid having a predetermined quantization dimension as a unit. The development circuit 211 computes the rate of occupancy of the figure for each pixel of the developed image. The occupancy rate of the figure in each pixel thus computed represents a pixel value. Hereinafter, a case where a pixel value of the developed image is represented by 8-bit gradation value data will be described. In this case, the pixel value of each pixel is represented by a gradation value of 0 to 255. If the pixel value is 0, the occupancy rate of the figure is 0%, and if the pixel value is 255, the occupancy rate of the figure is 100%. Note that the development circuit 211 may be eliminated in the case where a die-to-die (D-D) inspection mode is adopted as the defect inspection mode of the inspection apparatus 1.

The reference image generation circuit 212 performs a resizing process and a corner rounding process for the developed image. The resizing process is a process of resizing the figure pattern of the developed image. The corner rounding process is a process of rounding corner portions of the figure pattern after the resizing process. Then, the reference image generation circuit 212 extracts a contour of the figure pattern from the developed image after the resizing process and the corner rounding process to generate a reference image (contour image). The reference image generation circuit 212 transmits the generated reference image to the comparison circuit 215 and the storage device 22. Note that the reference image generation circuit 212 applies one of the contour images generated in the contour extraction circuit 214 as a reference image in the case where a die-to-die (D-D) inspection mode is adopted as the defect inspection mode of the inspection apparatus 1.

The image acquisition circuit 213 acquires captured-image data from the detector 15 of the image capturing mechanism 10. The image acquisition circuit 213 generates gradation-value data of an SEM image based on the captured-image data, and transmits it to the contour extraction circuit 214 and the storage device 22.

The contour extraction circuit 214 extracts contour data of the pattern based on the SEM image data to generate an inspection image (contour image). The contour extraction circuit 214 of the present embodiment generates an area image based on the SEM image. The area image is generated based on gradation values of pixels (also referred to as “SEM pixels” hereinafter) of the SEM image. Details of the area image will be described later. The contour extraction circuit 214 extracts contour data of the pattern from the area image. The contour data includes information related to contour points of the pattern and a contour line joining the contour points. In other words, the contour data includes representative values of coordinates through which a contour line passes in each pixel (a pixel of an area image), that is, coordinate positions of contour points, and information on normal directions of contour vectors at the contour points. Details of the contour extraction circuit 214 will be described later.

The comparison circuit 215 compares the inspection image with the reference image to detect a defect. More specifically, the comparison circuit 215 performs an alignment between the inspection image and the reference image to calculate an amount of shift of the inspection image relative to the reference image. The comparison circuit 215 measures an amount of distortion of the inspection image based on, for example, variations in the shift amount in the plane of the sample 30 to calculate a distortion coefficient. It is preferable, for example, that the distortion amount is represented by a polynomial model of coordinates (X, Y) in the image and the distortion coefficient is set as a coefficient of the polynomial. The comparison circuit 215 compares the inspection image with the reference image using an appropriate algorithm in consideration of the shift amount and the distortion coefficient. If an error between the inspection image and the reference image exceeds a preset value, the comparison circuit 215 determines that there is a defect in the corresponding coordinate position of the sample 30.

The storage device 22 stores data and programs related to defect inspection. The storage device 22 stores, for example, design data 221, inspection condition parameter information 222, inspection data 223, threshold data 224, and the like. For example, the inspection condition parameter information 222 contains image capturing conditions of the image capturing mechanism 10, reference image generation conditions, SEM image contour extraction conditions, defect detection conditions, and the like. The inspection data 223 contains image data (developed image, reference image, SEM image, and inspection image) and data (coordinates, sizes, etc.) related to detected defects. The threshold data 224 contains data such as a frequency threshold, an area threshold, a variance threshold, and a distance threshold. The storage device 22 may store the defect inspection program 225 as a non-transitory storage medium. The defect inspection program 225 is a program for causing the control circuit 21 to execute defect inspection.

The storage device 22 may include various storage devices such as a magnetic disk storage device (hard disk drive (HDD)) and a solid state drive (SSD) as external storages. The storage device 22 may further include, for example, a drive for reading programs from a compact disc (CD), a digital versatile disc (DVD), or the like as a non-transitory storage medium.

The display device 23 includes a display screen (e.g., a liquid crystal display (LCD)), an electroluminescence (EL) display, or the like. The display device 23 displays, for example, a result of defect detection under the control of the control circuit 21.

The input device 24 is an input device such as a keyboard, a mouse, a touch panel, or a button switch.

The communication device 25 is a device coupled to a network in order to transmit and receive data to and from an external device. For such communications, various communication standards may be used. For example, the communication device 25 receives design data 221 from an external device and transmits inspection data 223 and the like to the external device.

### 1.2 Configuration of Contour Extraction Circuit

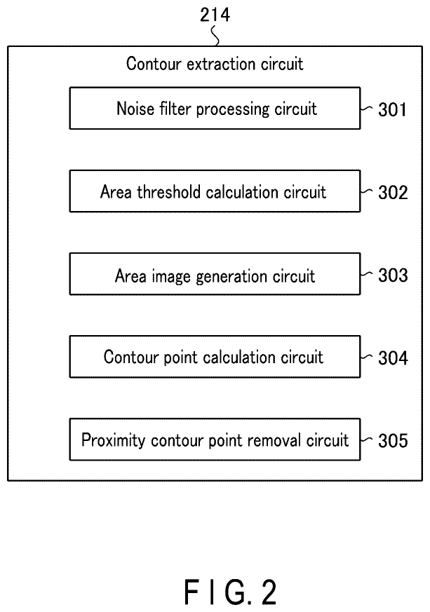

Next, an example of a configuration of the contour extraction circuit 214 will be described below with reference to FIG. 2. FIG. 2 is a block diagram of the contour extraction circuit 214. Note that the function of each block of the contour extraction circuit 214 may be realized by the control circuit 21 executing firmware or the like or may be realized by a dedicated circuit.

As shown in FIG. 2, the contour extraction circuit 214 includes a noise filter processing circuit 301, an area threshold calculation circuit 302, an area image generation circuit 303, a contour point calculation circuit 304, and a proximity contour point removal circuit 305. The data generated by each unit can be stored in the storage device 22 each time.

The noise filter processing circuit 301 is a circuit configured to reduce (remove) noise from SEM image data. The noise filter processing circuit 301 acquires SEM image data from the image acquisition circuit 213. Then, the noise filter processing circuit 301 reduces noise at the end of the figure pattern of the SEM image to smoothen the shape of the end of the pattern. For the noise filtering process, a general filter such as a Gaussian filter or a bilateral filter can be used.

The area threshold calculation circuit 302 is a circuit configured to calculate an area threshold. The area threshold is a threshold used for generating an area image, to be discussed later. The area threshold calculation circuit 302 generates a histogram of gradation values of the SEM image, and calculates the area threshold from the histogram. Details of the method of calculating the area threshold will be described later. The area threshold may be stored in the storage device 22 as threshold data 224.

The area image generation circuit 303 is a circuit configured to generate an area image. The area image generation circuit 303 generates a level line corresponding to or a line on a single pixel region based on one-dimension polynomial function using an area threshold by interpolating gradation values of the respective vertexes of the single pixel region provided in a matrix of n×m SEM pixels with n neighboring rows and m neighboring columns of an SEM image (where n and m are integers of 2 or greater). In the present embodiment, a case will be described where a linear interpolation (bilinear interpolation) is used as the interpolation method. In this case, n=m=2, namely, a matrix of four SEM pixels with two rows and two columns is assumed. More specifically, the area image generation circuit 303 generates a level line corresponding to or a line on an area pixel based on one-dimension polynomial function using an area threshold by interpolating gradation values at the respective vertexes of a single pixel region (referred to as an “area pixel” hereinafter) whose vertexes are the central points of two neighboring rows x two neighboring columns of SEM pixels of an SEM image. Note that the interpolation method is not limited to linear interpolation. As the interpolation method, biquadratic interpolation may be used. In this case, n=m=3, namely, an area pixel is provided in a matrix of nine SEM pixels with three rows and three columns. As the interpolation method, bi-cubic interpolation may also be used. In this case, n=m=4, namely, an area pixel is provided in a matrix of sixteen SEM pixels with 4 rows and 4 columns. The area image generation circuit 303 calculates an occupancy rate in area (simply referred to as an “area”) occupied by a portion with a value equal to or greater than an area threshold in each area pixel. An area of an area pixel may be denoted by the occupancy rate of 0 to 1, or may be expressed by 8-bit gradation-value data (0 to 255 gradation values), similarly to an SEM pixel. If, for example, all the gradation values of four SEM pixels corresponding to the four vertexes of an area pixel are equal to or greater than the area threshold, the area of the area pixel is 1. In this case, the area pixel is expressed by white. On the other hand, if all the gradation values of the four SEM pixels corresponding to the four vertexes of the area pixel are less than the area threshold, the area of the area pixel is 0. In this case, the area pixel is expressed by black. The area image generation circuit 303 generates an area image by calculating an area of a portion of each area pixel having a value equal to or greater than the area threshold, while shifting the SEM pixels one by one. The area image may be stored in the storage device 22 as inspection data 223.

Also, the area image generation circuit 303 may execute two filtering processes to suppress extraction of false contour points in the area image.

A first filtering process is a process corresponding to an isolated pixel. If, for example, a gradation value of a central SEM pixel of a matrix of 3×3 SEM pixels of an SEM image is less than an area threshold, and gradation values of the eight peripheral neighboring SEM pixels are equal to or greater than the area threshold, 2×2 area pixels including, at their vertexes, a central point of a central SEM pixel are determined to be white (i.e., area “1”). In other words, if an SEM pixel with a gradation value less than the area threshold is isolated, namely, if an SEM pixel with a gradation value less than the area threshold does not exist in the eight neighboring pixels, the area image generation circuit 303 determines that the area pixels based on the central SEM pixel are white. The area image generation circuit 303 may apply the first filtering process to a matrix of 5×5 SEM pixels.

The second filtering process is a process of suppressing extraction of false contouring in a case where the gradation values of the pixels are relatively close to an area threshold. It is a process of determining, if, for example, a variance of gradation values of 3×3 SEM pixels of an SEM image is equal to or lower than a preset variance threshold, each of the 2×2 area pixels based on the 3×3 SEM pixels to be white (i.e., area “1”) or black (i.e., area “0”). If, for example, a mean of the gradation values of the 3×3 SEM pixels is equal to or greater than the area threshold, the area image generation circuit 303 determines that the target 2×2 area pixels are white. On the other hand, if the mean of the gradation values of the 3×3 SEM pixels is less than the area threshold, the area image generation circuit 303 determines that the target 2×2 area pixels are black. The area pixels determined to be black or white do not include a level line. Note that the area image generation circuit 303 may apply a second filtering process to 5×5 SEM pixels.

The contour point calculation circuit 304 is a circuit configured to calculate contour points of an area image. The contour point calculation circuit 304 according to the present embodiment calculates a coordinate position and a normal-direction vector of a contour point in an area pixel (contour point candidate pixel) including a level line using, for example, a Sobel filter. That is, the contour point calculation circuit 304 calculates coordinate positions and normal-direction vectors in an area pixel having an area greater than 0 and smaller than 1. Details of the contour point extraction method will be described later.

The proximity contour point removal circuit 305 is a circuit configured to remove a proximity contour point. A proximity contour point is a contour point distanced from a neighboring contour point by a preset distance threshold or below. By removing the proximity contour point, errors in a process of estimating a contour line are reduced.

### 1.3 Flow of Overall Inspection Process

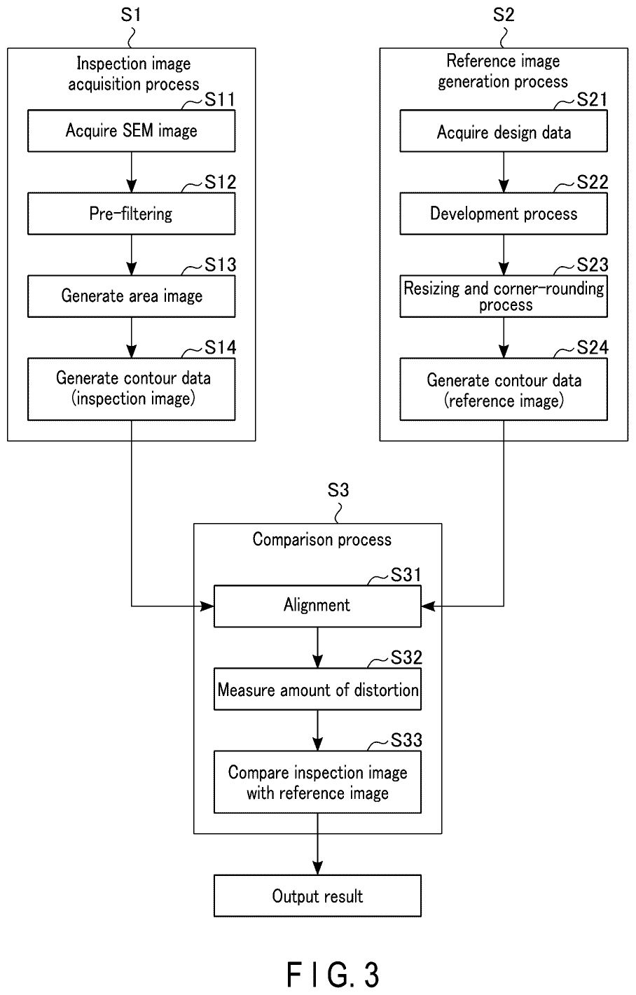

Next, a flow of the overall inspection process will be described with reference to FIG. 3. FIG. 3 is a flowchart of an inspection process.

As shown in FIG. 3, the inspection process roughly includes an inspection image acquisition process (step S1), a reference image generation process (step S2), and a comparison process (step S3).

### 1.3.1. Inspection Image Acquisition Process

First, an example of the inspection image acquisition process at step S1 will be described. The image acquisition circuit 213 acquires an SEM image of a sample 30 from the image capturing mechanism 10 (step S11). The image acquisition circuit 213 transmits the SEM image to the contour extraction circuit 214.

Subsequently, the noise filter processing circuit 301 of the contour extraction circuit 214 performs a pre-filtering process to remove (reduce) noise from the SEM image as pre-processing prior to generating an area image (step S12).

Subsequently, the contour extraction circuit 214 generates an area image using the SEM image subjected to the pre-filtering process (step S13).

Subsequently, the contour extraction circuit 214 generates contour data from the area image (step S14). That is, the contour extraction circuit 214 generates an inspection image (a contour image).

The contour extraction circuit 214 transmits the generated inspection image to the comparison circuit 215 and the storage device 22.

### 1.3.2 Reference Image Acquisition Process

Next, an example of the reference image acquisition process will be described. For example, the inspection apparatus 1 acquires the design data 221 via the communication device 25 (step S21). The acquired design data 221 is stored, for example, in the storage device 22.

The development circuit 211 reads the design data 221 from the storage device 22. Subsequently, the development circuit 211 executes a development process to develop (convert) the design data 221 into, for example, 8-bit image data (developed image) (step S22). Each pixel of the developed image has, as a pixel value, a value corresponding to an occupancy rate occupied by the figure of the design data 221 in the pixel. In the case of 8-bit image data, the pixel value is 0 if the occupancy rate of the design figure is 0%, and the pixel value is 255 if the occupancy rate is 100%. The development circuit 211 transmits the developed image to the reference image generation circuit 212 and the storage device 22.

Subsequently, the reference image generation circuit 212 performs a resizing process and a corner-rounding process for the developed image (step S23).

Subsequently, the reference image generation circuit 212 generates contour data of the pattern from the developed image subjected to the resizing process and the corner-rounding process (step S24). That is, the reference image generation circuit 212 generates a reference image (contour image). The reference image generation circuit 212 transmits the generated reference image to the comparison circuit 215 and the storage device 22.

### 1.3.3 Comparison Process

Next, an example of the comparison process will be described. First, the comparison circuit 215 performs alignment between the inspection image and the reference image (step S31) to align a pattern in the inspection image and a pattern in the reference image. For example, the comparison circuit 215 obtains a relative vector between each contour line position of the inspection image and a corresponding contour line position of the reference image, and uses a mean of the relative vectors as an alignment shift amount. That is, the comparison circuit 215 calculates an alignment shift amount of the inspection image relative to the reference image.

Subsequently, the comparison circuit 215 measures an amount of distortion of the inspection image (step S32) to calculate a distortion coefficient. For example, a positional deviation may occur between pattern coordinate information based on the design data 221 and pattern coordinates calculated from a captured image due to stage movement accuracy, distortion of the sample 30, or the like. The comparison circuit 215 measures, for example, an amount of distortion of the inspection image from a distribution of local alignment shift amounts in the plane of the sample 30 to calculate a distortion coefficient.

Subsequently, the comparison circuit 215 compares the inspection image with the reference image (step S33). The comparison circuit 215 detects a defect based on a result of the comparison. In other words, the comparison circuit 215 calculates a pixel-by-pixel positional deviation amount between the contour line of the inspection image and the contour line of the reference image based on the relative vector and the distortion coefficient. Then, the comparison circuit 215 detects a defect based on the positional deviation amount. The result of the comparison is output to the storage device 22 or the display device (monitor) 23.

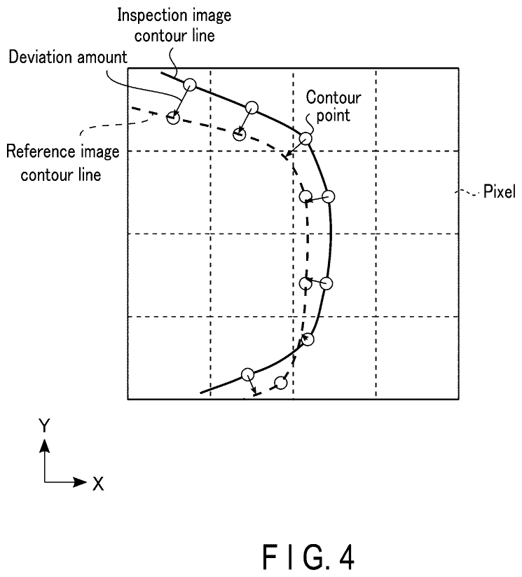

FIG. 4 shows a specific example of comparison between an inspection image and a reference image. FIG. 4 is a diagram showing a specific example of 4×4 pixels including a contour line of the inspection image and a contour line of the reference image.

As shown in FIG. 4, the comparison circuit 215 calculates a distance from each contour point of the inspection image to the contour line of the reference image (a positional deviation amount). If the positional deviation amount exceeds a preset threshold value, the comparison circuit 215 determines that there is a defect.

After storing a result of the defect inspection in the storage device 22, the control circuit 21 may display the result on, for example, the display device 23, or may output it to an external device (e.g., a review device) via the communication device 25.

### 1.4. Details of Area Image Generation Process and Contour Data Generation Process

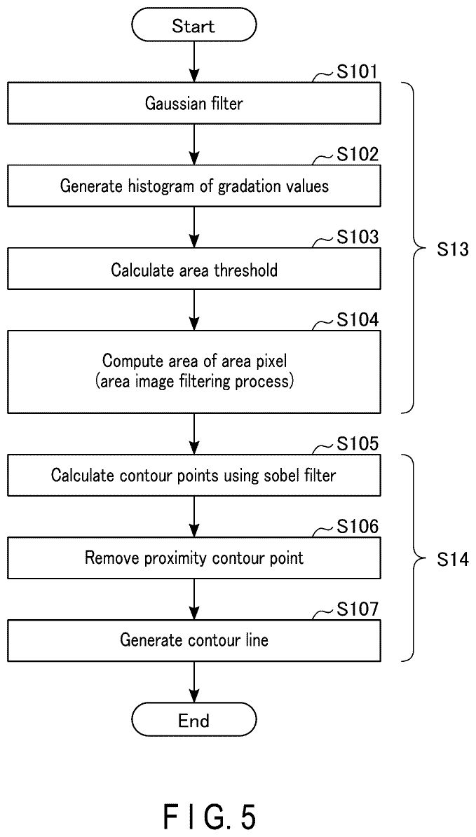

Next, referring to FIG. 5, details of the area image generation process at step S13 described with reference to FIG. 3 and the contour data generation process at step S14 will be described. FIG. 5 is a flowchart for generating the area image and generating contour data.

As shown in FIG. 5, processes at steps S101 to S104 are executed as the area image generation process (step S13). Steps S105 to S107 are executed as the contour data generation process (step S14). Details of each of the steps will be described.

### [Step S101]

The noise filter processing circuit 301 executes a filtering process using a Gaussian filter on an SEM image subjected to the pre-filtering process. Thereby, the effects of noise and white band in the SEM image are eased. Note that, at step S101, the filtering process using a filter other than the Gaussian filter may be applied. Also, step S101 may be omitted.

### [Step S102]

The area threshold calculation circuit 302 generates a histogram of gradation values of the SEM image. The area threshold calculation circuit 302 determines, from the histogram, a maximum value and a minimum value of gradation values corresponding to a pattern. At this time, the area threshold calculation circuit 302 determines a minimum value and a maximum value from a range of gradation values with a larger number of pixels than the preset frequency threshold, to reduce the effect of noise. The area threshold calculation circuit 302 may divide the SEM image into a plurality of regions, and create a histogram for each region. In this case, the area threshold calculation circuit 302 calculates an area threshold for each region.

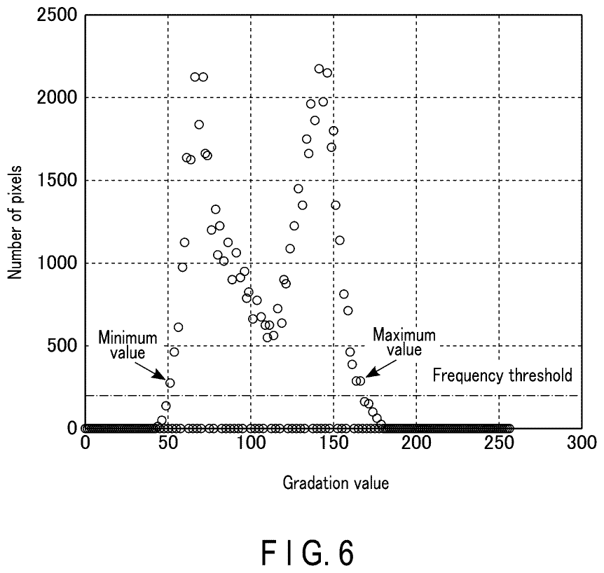

Referring to FIG. 6, a specific example of a histogram will be described. FIG. 6 is a specific example of a histogram showing a relationship between gradation values and the number of pixels of an SEM image.

As shown in FIG. 6, the lateral axis of the graph represents gradation values of the SEM image. The vertical axis of the graph represents a number of SEM pixels corresponding to each of the gradation values. In the example of FIG. 6, the frequency threshold is set to be “200”. The area threshold calculation circuit 302 determines a minimum value and a maximum value from gradation values each corresponding to the number of pixels exceeding the frequency threshold (i.e., 200).

### [Step S103]

The area threshold calculation circuit 302 calculates an area threshold. The area threshold calculation circuit 302 performs a computation of Formula 1, and calculates an area threshold Z.

$$\begin{matrix}[ Formula 1 ] & \\ Z = k ( maximum - minimum ) + minimum & ( 1 )\end{matrix}$$

Here, the variable k denotes a ratio in a range between the minimum value and the maximum value. The variable k may be arbitrary set in the range of 0<k<1. If, for example, the area threshold Z is a midpoint between the minimum value and the maximum value, k=0.5 is set.

### [Step S104]

The area image generation circuit 303 computes an area of the area pixel. At this time, the area image generation circuit 303 executes the first filtering process and the second filtering process. That is, the area image generation circuit 303 executes an area image filtering process. The area image generation circuit 303 generates an area image by repeatedly computing the area of the area pixel, while shifting the SEM pixels one by one.

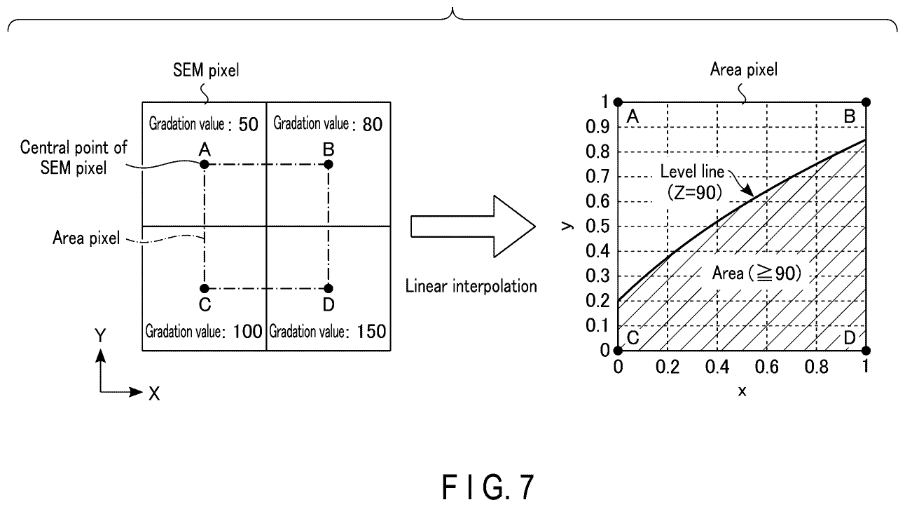

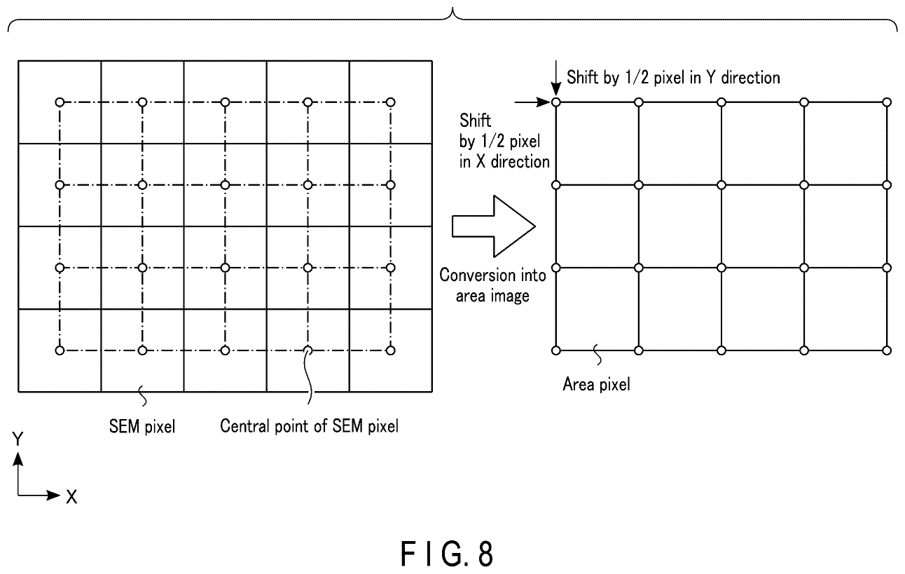

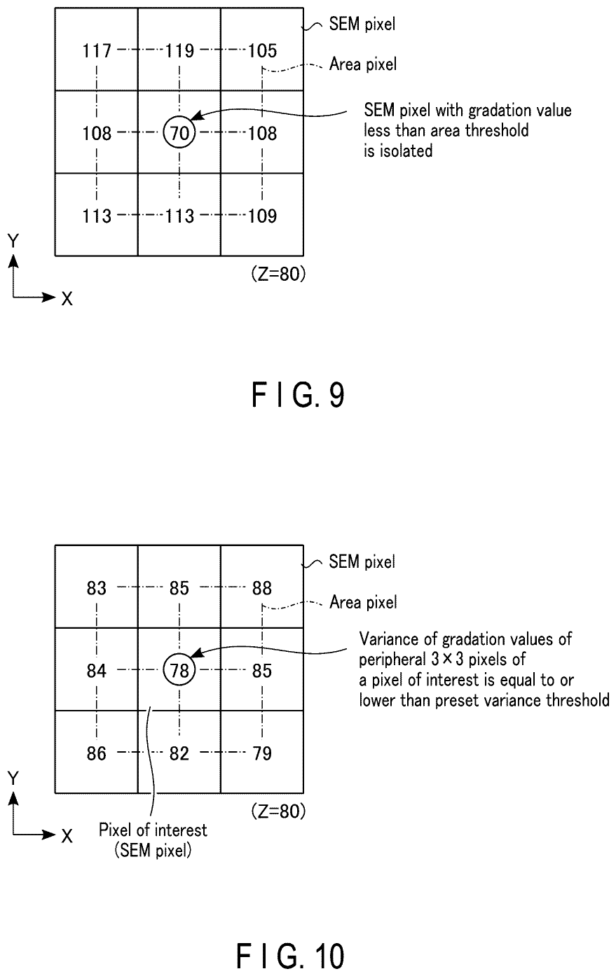

Referring to FIGS. 7 to 10, a specific example of generating an area image will be described. FIG. 7 is a diagram showing a specific example of calculating an area of an area pixel. FIG. 8 is a diagram showing a relationship between an SEM image and an area image. FIG. 9 is a diagram showing a specific example of the first filtering process. FIG. 10 is a diagram showing a specific example of the second filtering process.

FIG. 7 shows, at the left, 2×2 SEM pixels. It is assumed, for example, that an SEM pixel at the upper left has a gradation value of 50, and has a central point “A”. It is assumed that an SEM pixel neighboring the SEM pixel with the central point “A” in the X direction has a gradation value of 80, and has a central point “B”. It is assumed that an SEM pixel neighboring the SEM pixel with the central point “A” in the Y direction has a gradation value of 100, and has a central point “C”. It is assumed that an SEM pixel neighboring the SEM pixel with the central point “C” in the X direction has a gradation value of 150, and has a central point “D”.

The area image generation circuit 303 generates an area pixel whose vertexes are “A” to “D” of the 2×2 SEM pixels. In other words, an area pixel is generated at the center of the 2×2 SEM pixels. Accordingly, the size of a single SEM pixel and the size of a single area pixel are equal. Also, area pixels are formed at coordinate positions shifted by ½ pixels in the X and Y directions from the SEM pixels.

The area image generation circuit 303 performs linear interpolation of gradation values of four vertexes “A” to “D” (i.e., central points “A” to “D” of the four SEM pixels) of each area pixel. More specifically, if, for example, an area threshold Z is 90 (Z=90), the area image generation circuit 303 calculates a level line y that satisfies Z=90 in each area pixel.

The level line y is expressed by, for example, Formula (2).

$$\begin{matrix}[ Formula 2 ] & \\ y = - a / c + ( ( ab / c ) + z - d ) / ( cx + b ) & ( 2 )\end{matrix}$$

Here, the variables a to d are respectively calculated by computation formulas a=D−C, b=A−C, c=C+B−D−A, and d=C. A to D represent gradation values at the vertexes “A” to “D”. In the example of FIGS. 7, A=50, B=80, C=100, and D=150. Accordingly, the variables a to d satisfy a=50, b=−50, c=−20, and d=100.

The area image generation circuit 303 performs a computation of Formula (3) (i.e., an integral of Formula (2)), and calculates an area of a portion equal to or greater than the area threshold Z.

$$\begin{matrix}[ Formula 3 ] & \\ \int ydx = - ( a / c ) x + ( ( ab / c + z - d ) / c ) log ( - cx - b ) & ( 3 )\end{matrix}$$

In the example of FIG. 7, an area of a portion of an area pixel compliant with the area threshold 90 is 0.5653.

Note that, if A+D=B+C, then c=0. In this case, the level line y is expressed by Formula (4).

$$\begin{matrix}[ Formula 4 ] & \\ y = ( - ax + z - d ) / b & ( 4 )\end{matrix}$$

In this case, the area image generation circuit 303 performs a computation of Formula (5) (i.e., an integral of Formula (4)), and calculates an area of a portion equal to or greater than the area threshold Z.

$$\begin{matrix}[ Formula 5 ] & \\ \int ydx = ( ( z - d ) / b ) x - ( a / 2 b ) {x}^{2} & ( 5 )\end{matrix}$$

If D=B and A=C, then b=0 and c=0. In this case, the level line is expressed by Formula (6).

$$\begin{matrix}[ Formula 6 ] & \\ x = ( z - d ) / a & ( 6 )\end{matrix}$$

As shown in FIG. 8, the area image generation circuit 303 generates an area image by repeatedly calculating the area of the area pixel, while shifting the SEM pixels one by one. At this time, the area pixels are formed at coordinate positions shifted by ½ pixels in the X and Y directions relative to the SEM pixels. For example, the area image is corrected for position and compared with the reference image in the alignment (step S31) at the comparison process (step S3).

Next, a specific example of the first filtering process will be described.

It is assumed that, in 3×3 SEM pixels shown in FIG. 9, gradation values of the three top SEM pixels are, from left to right, 117, 119, and 105. It is assumed that gradation values of the three middle SEM pixels are, from left to right, 108, 70, and 108. It is assumed that gradation values of the three bottom SEM pixels are, from left to right, 113, 113, and 109. The area threshold is, for example, 80. In this case, the gradation value of the central SEM pixel is less than the area threshold, and gradation values of the eight peripheral SEM pixels are equal to or greater than the area threshold. That is, an SEM pixel with a gradation value less than the area threshold is isolated. In this case, the area image generation circuit 303 determines that four (2×2) area pixels including the central point of the central SEM pixel include false contouring. Then, the area image generation circuit 303 determines each area pixel to be white (i.e., area “1”).

Next, a specific example of the second filtering process will be described.

It is assumed that, in 3×3 SEM pixels shown in FIG. 10, gradation values of the three top SEM pixels are, from left to right, 83, 85, and 88. It is assumed that gradation values of the three middle SEM pixels are, from left to right, 84, 78, and 85. It is assumed that gradation values of the three bottom SEM pixels are, from left to right, 86, 82, and 79. The area threshold is, for example, 80. The area image generation circuit 303 calculates a variance of gradation values of peripheral 3×3 pixels of a pixel of interest. In the example of FIG. 10, a variance V is 10.5. If, for example, the variance threshold is 20, the variance V is smaller than a variance threshold. In this case, the area image generation circuit 303 determines that four (2×2) area pixels including the central point of the central SEM pixel, which is a pixel of interest, include false contouring. In the example of FIG. 10, a mean of gradation values of 3×3 SEM pixels is equal to or greater than the area threshold. In this case, the area image generation circuit 303 determines that the target area pixel is white (i.e., area “1”). On the other hand, if the mean of gradation values of the 3×3 SEM pixels is less than the area threshold, the area image generation circuit 303 determines that the target area pixel is black (i.e., area “0”).

### [Step S105]

The contour point calculation circuit 304 calculates contour points from the area image using a Sobel filter.

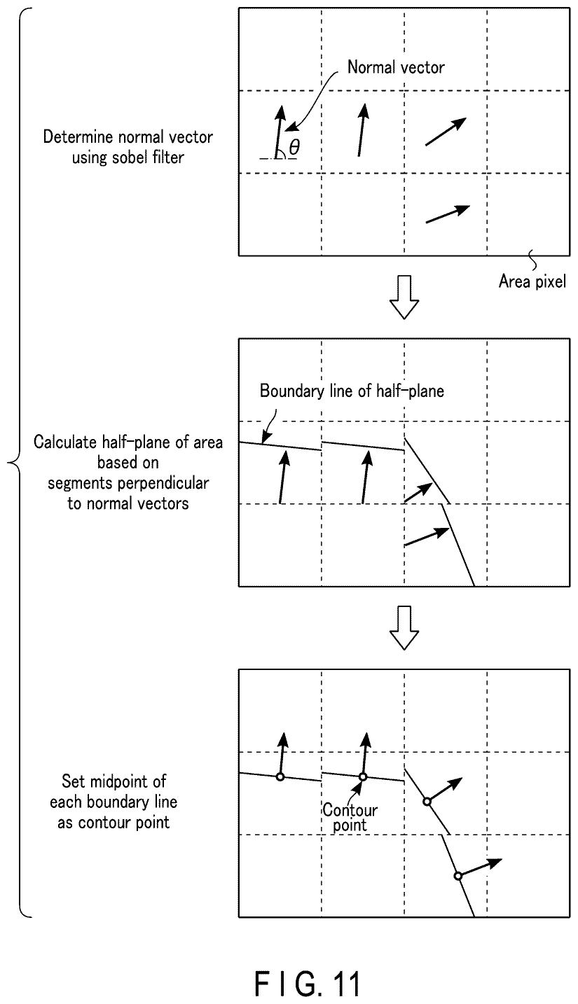

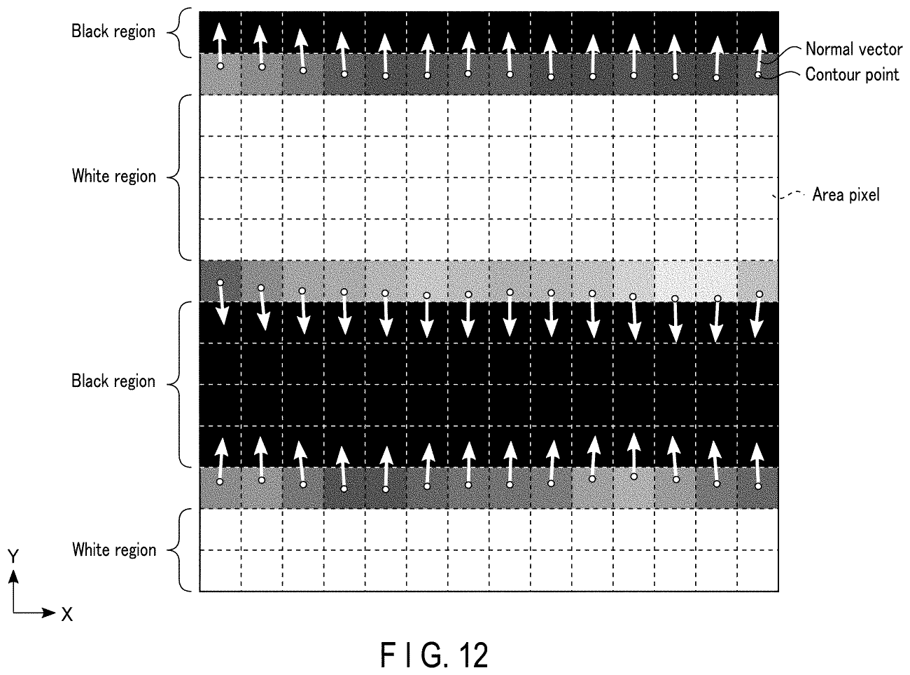

Referring to FIGS. 11 and 12, a specific example of calculating contour points will be described. FIG. 11 is a diagram showing a specific example of calculating contour points. FIG. 12 is a diagram showing a specific example of an area image. In the example of FIG. 12, 14×14 area pixels are shown. Also, in the example of FIG. 12, contour points and normal vectors are shown on area pixels for which the contour points have been calculated.

As shown in FIG. 11, the contour point calculation circuit 304 obtains a normal direction (a normal vector) of contouring in a pixel of interest using the Sobel filter. More specifically, the contour point calculation circuit 304 performs a convolution operation of the area image with an X-direction kernel of the Sobel-filter and a convolution operation of the area image with a Y-direction kernel of the Sobel-filter. Then, the contour point calculation circuit 304 calculates, for the pixel of interest of the area pixels, a normal angle θ of a contour vector obtained by synthesizing an X-direction computation value and a Y-direction computation value. Assuming, for example, that the X-direction value and the Y-direction value after the Sobel filter process are Fx and Fy, respectively, the formula for the normal-direction angle θ is expressed by θ=a tan(Fy/Fx) (if Fx=0, θ=π/2).

Subsequently, the contour point calculation circuit 304 calculates a half-plane having the same area as the area pixel and having boundary lines perpendicular to the respective normal vectors obtained by the Sobel filter.

Subsequently, the contour point calculation circuit 304 sets a midpoint position of each boundary line as a coordinate position of a contour point. The Coordinate position of contour point is set in units of sub-pixels into which a single area pixel is divided.

The example of FIG. 12 shows a line-and-space configuration in which line patterns extend in the X direction. The white area pixel regions correspond to the line patterns, and the black area pixels correspond to the space. In this case, a contour point and a normal vector are calculated for each area pixel sandwiched between the white area pixels and the black area pixels in the Y direction.

### [Step S106]

The proximity contour point removal circuit 305 removes a proximity contour point. The proximity contour point removal circuit 305 determines, if a distance between a target contour point and an adjacent contour point is less than a preset distance threshold Lt, that the two contour points are in proximity to each other, and removes one of the contour points as a proximity contour point. Of the two contour points in proximity to each other, which contour point is to be removed is arbitrary set. For example, of the two contour points in proximity to each other, whichever contour point is farther from the center of the area pixel may be removed. Alternatively, whichever contour point corresponds to, for example, an SEM pixel (area pixel) to be scanned later in scanning (imaging) of the sample 30 with an electron beam may be removed.

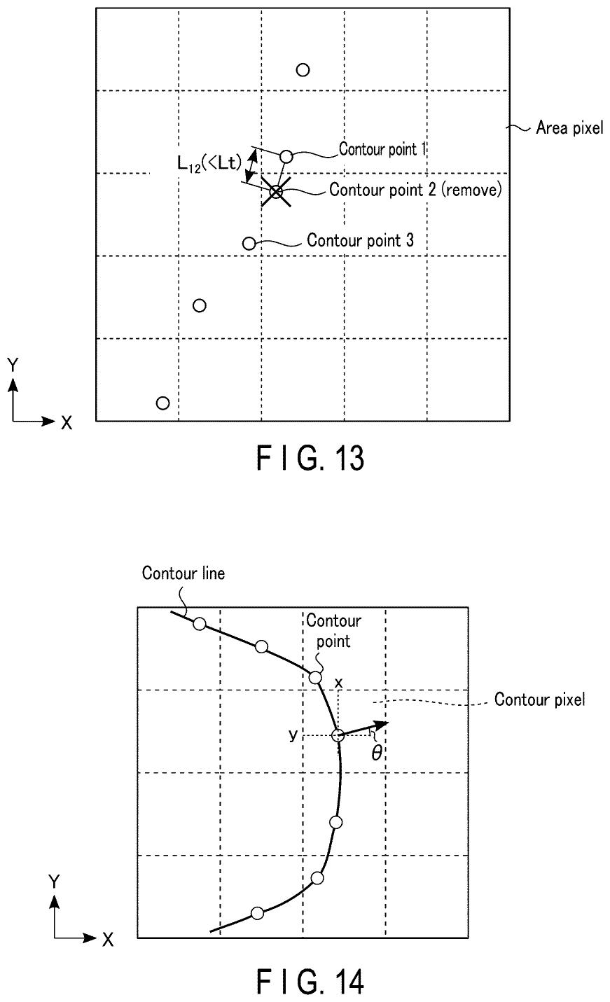

In FIG. 13, a specific example of a proximity contour point is shown. FIG. 13 is a diagram showing a specific example of a proximity contour point. In the example of FIG. 13, 5×5 area pixels centered around a proximity contour point are shown.

As shown in FIG. 13, for example, the proximity contour point removal circuit 305 calculates a distance from a contour point 2, to be confirmed as to whether it is a proximity contour point, to adjacent contour points 1 and 3. In the example of FIG. 13, since a distance L₁₂ between the contour points 1 and 2 is less than a distance threshold Lt, the contour point 2 is removed.

### [Step S107]

The contour extraction circuit 214 defines area pixels including contour points remaining after the removal of the proximity contour point as contour pixels. Then, the contour extraction circuit 214 generates a contour line joining the contour points. Thereby, an inspection image is generated. The contour extraction circuit 214 causes the storage device 22 to store a coordinate position of the contour point and an angle θ of a normal vector in each contour pixel, as well as the inspection image.

In FIG. 14, a specific example of an inspection image is shown. FIG. 14 is a diagram showing a specific example of an inspection image. In the example of FIG. 14, 4×4 area pixels are shown.

As shown in FIG. 14, the contour extraction circuit 214 generates a contour line joining contour points of neighboring contour pixels.

### 1.5. Advantageous Effects of Present Embodiment

If, for example, an edge-to-edge distance of a pattern is smaller than a size of an edge filter in an electron-beam defect inspection apparatus, it may be difficult to extract a contour line, resulting in a gentle edge profile. Also, uneven brightness may occur due to a charge-up, etc. of a sample. Uneven brightness may be a cause of erroneous detection of a contour line.

On the other hand, with the configuration of the present embodiment, the inspection apparatus 1 is capable of generating an area image based on an SEM image, and generating contour data (an inspection image) based on the area image. More specifically, the inspection apparatus 1 is capable of generating an area pixel based on 2×2 SEM pixels. The inspection apparatus 1 is capable of generating a level line or a line on an area pixel based on one-dimension polynomial function using based on an area threshold in an area pixel, and calculating an area of a portion equal to or greater than the area threshold in the area pixel. The inspection apparatus 1 is capable of calculating a contour point and a normal vector of the contour point in the area pixel. It is thereby possible to reduce an occurrence of a gentle edge profile and the effect of uneven brightness. This improves the precision in extracting a contour line of a pattern in the inspection image. Also, by generating the area image, processing can be performed for adjacent pixels in an overlapping manner, thus making it possible to generate a smooth contour point between the neighboring pixels.

### 2. Second Embodiment

Next, a second embodiment will be described. In the second embodiment, a method of generating contour data different from that of the first embodiment will be described. Hereinafter, matters different from those of the first embodiment will be mainly described.

### 2.1. Details of Area Image Generation Process and Contour Data Generation Process

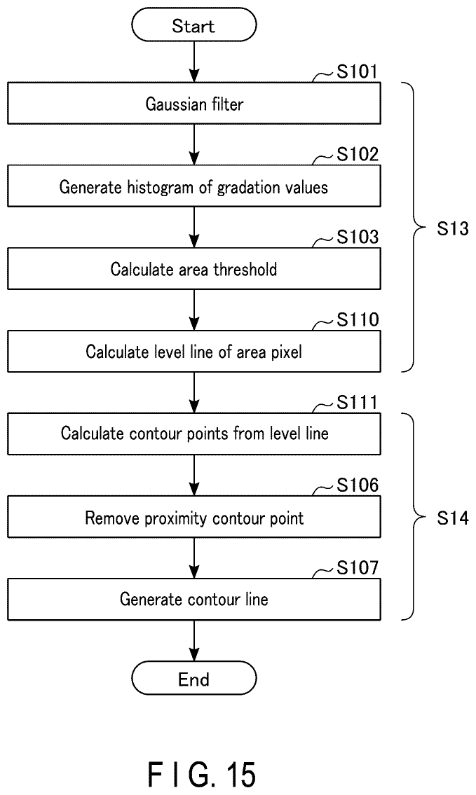

Referring to FIG. 15, details of the area image generation process at step S13 described with reference to FIG. 3 and the contour data generation process at step S14 will be described. FIG. 15 is a flowchart of the area image generation process and the contour data generation process.

As shown in FIG. 15, in the present embodiment, processing at steps S101 to S103 and S110 is executed as the area image generation process (step S13). Then, steps S111, S106, and S107 are executed in sequence as the contour data generation process (step S14). Each of the steps S101 to S103, S106, and S107 is similar to that in FIG. 5 of the first embodiment.

### [Step S110]

After calculation of the area threshold has ended at step S103, the area image generation circuit 303 calculates a level line of the area pixel. That is, in the present embodiment, the area computation of the area pixel is omitted. More specifically, a level line of the area pixel is calculated by Formula (2) described with reference to step S104 of the first embodiment, and the area calculation of Formula (3) is omitted.

### [Step S111]

After calculation of the level line of the area pixel has ended at step S110, the contour point calculation circuit 304 calculates a contour point from the level line of the area pixel.

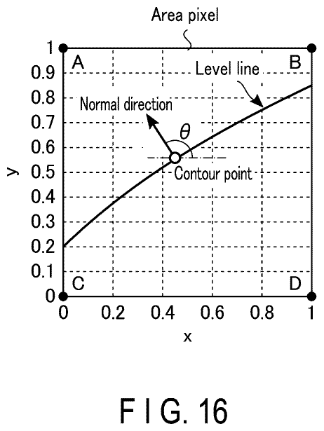

Referring to FIG. 16, a specific example of calculating a contour point will be described. FIG. 16 is a diagram showing a specific example of calculating a contour point.

As shown in FIG. 16, the contour point calculation circuit 304 sets a contour point at a midpoint of the level line of the area pixel calculated at step S110, and calculates a coordinate position of the contour point. Then, the contour point calculation circuit 304 calculates an angle θ of a normal vector of the contour point, defined as a normal direction of the level line.

### 2.2. Advantageous Effects of Present Embodiment

With the configuration of the present embodiment, it is possible to obtain advantageous effects similar to those of the first embodiment.

Moreover, with the configuration of the present embodiment, the contour point calculation circuit 304 is capable of calculating a contour point and its normal vector from a level line of an area pixel. That is, the contour point calculation circuit 304 is capable of calculating a contour point and its normal vector without calculating a normal vector using a Sobel filter and a contour point based on a boundary line. It is thereby possible, with the inspection apparatus 1, to improve the speed of processing for acquiring an inspection image.

### 3. Third Embodiment

Next, a third embodiment will be described. In the third embodiment, a case will be described where the first embodiment is applied to a D-D mode. Hereinafter, matters different from those of the first and second embodiments will be mainly described.

### 3.1 Flow of Overall Inspection Process

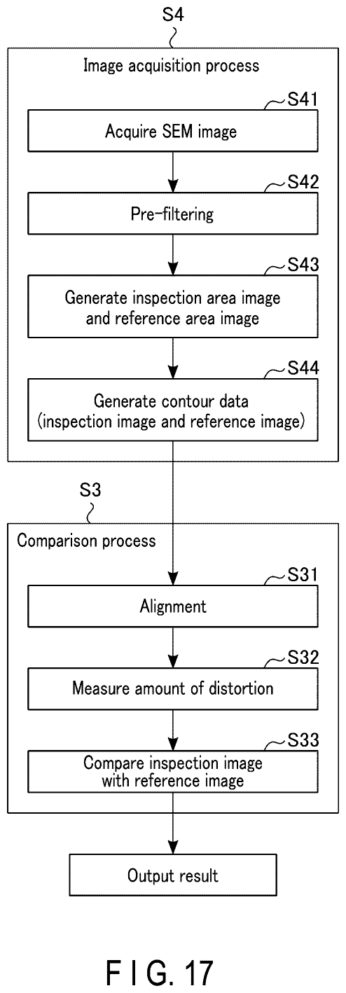

First, an example of a flow of an overall inspection process will be described with reference to FIG. 17. FIG. 17 is a flowchart of the inspection process.

As shown in FIG. 17, the inspection process of the present embodiment includes the image acquisition process (step S4) and the comparison process (step S3). The comparison process is similar to step S3 in FIG. 3 of the first embodiment.

An example of the image acquisition process at step S4 will be described. In the present embodiment, an inspection image and a reference image are generated through the image acquisition process. In the description that follows, an SEM image used for generating an inspection image will also be referred to as an “inspection SEM image” or a “Left image”. On the other hand, an SEM image used for generating a reference image is also referred to as a “reference SEM image” or a “Right image”.

The image acquisition circuit 213 acquires an inspection SEM image and a reference SEM image from the image capturing mechanism 10 (step S41). The image acquisition circuit 213 transmits the inspection SEM image and the reference SEM image to the contour extraction circuit 214.

Subsequently, the noise filter processing circuit 301 of the contour extraction circuit 214 performs a pre-filtering process for the inspection SEM image and the reference SEM image (step S42).

Subsequently, the contour extraction circuit 214 generates an area image (also referred to as an “inspection area image” hereinafter) using the inspection SEM image subjected to the pre-filtering process. The contour extraction circuit 214 generates, using the reference SEM image subjected to the pre-filtering process, an area image (also referred to as “reference area image” hereinafter) (Step S13).

Subsequently, the contour extraction circuit 214 generates contour data from each of the inspection area image and the reference area image (step S14). That is, the contour extraction circuit 214 generates an inspection image (contour image) and a reference image (contour image).

The contour extraction circuit 214 transmits the inspection image and the reference image to the comparison circuit 215 and the storage device 22.

### 3.2. Details of Area Image Generation Process and Contour Data Generation Process

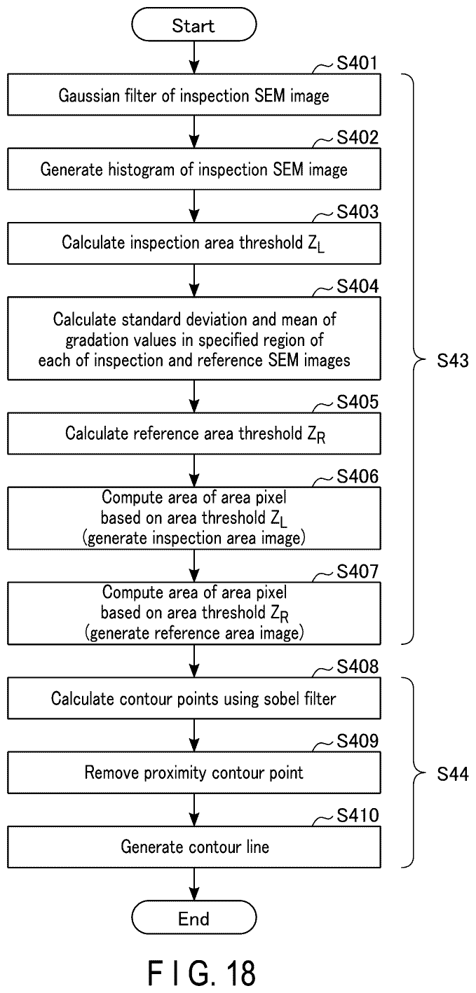

Referring to FIG. 18, details of the area image generation process and the contour data generation process will be described. FIG. 18 is a flowchart for generating an area image and generating contour data.

As shown in FIG. 18, processes at steps S401 to S407 are executed as the area image generation process (step S43). Steps S408 to S410 are executed as the contour data generation process (step S44). Details of each of the steps will be described.

### [Step S401]

The noise filter processing circuit 301 executes a Gaussian filter process on the inspection SEM image subjected to the pre-filtering process, in a manner similar to step S101 in FIG. 5 of the first embodiment. Note that, at step S401, the filtering process using a filter other than the Gaussian filter may be applied. Step S401 may be omitted.

### [Step S402]

The area threshold calculation circuit 302 generates a histogram of gradation values of the inspection SEM image, in a manner similar to step S102 in FIG. 5 of the first embodiment. The area threshold calculation circuit 302 determines, from the histogram, a maximum value and a minimum value from gradation values corresponding to a pattern. At this time, the area threshold calculation circuit 302 determines the minimum value and the maximum value from a range of gradation values with a larger number of pixels than the preset frequency threshold, to reduce the effect of noise. Note that, the area threshold calculation circuit 302 may divide an SEM image into a plurality of regions (frames), and create a histogram for each region. In this case, the area threshold calculation circuit 302 calculates an area threshold for each region.

### [Step S403]

The area threshold calculation circuit 302 calculates an area threshold Z_{L} (also referred to as an “inspection area threshold Z_{L}” hereinafter) of the Left image (inspection SEM image). The inspection area threshold Z_{L} is calculated in a manner similar to step S103 in FIG. 5 of the first embodiment.

### [Step S404]

The area threshold calculation circuit 302 calculates a standard deviation and a mean of gradation values in a specified region of each of the inspection SEM image (Left image) and the reference SEM image (Right image).

### [Step S405]

The area threshold calculation circuit 302 computes the Formula (7), and calculates an area threshold Z_{R} (also referred to as a “reference area threshold Z_{R}” hereinafter) of the Right image (reference SEM image). The Left image and the Right image are images having substantially the same properties, namely, the same pattern. Thus, the area threshold calculation circuit 302 may calculate the reference area threshold Z_{R} by threshold correction based on a gain offset.

$$\begin{matrix}[ Formula 7 ] & \\ {Z}_{R} = {Z}_{L} ( {σ}_{R} / {σ}_{L} ) + {μ}_{R} - {μ}_{L} ( {σ}_{R} / {σ}_{L} ) & ( 7 )\end{matrix}$$

Here, Z_{L} is an area threshold of the Left image (inspection SEM image). μ_{L} is a mean of gradation values of the Left image. σ_{L} is a standard deviation of gradation values of the Left image. M_{R} is a mean of gradation values of the Right image. σ_{R} is a standard deviation of gradation values of the Right image.

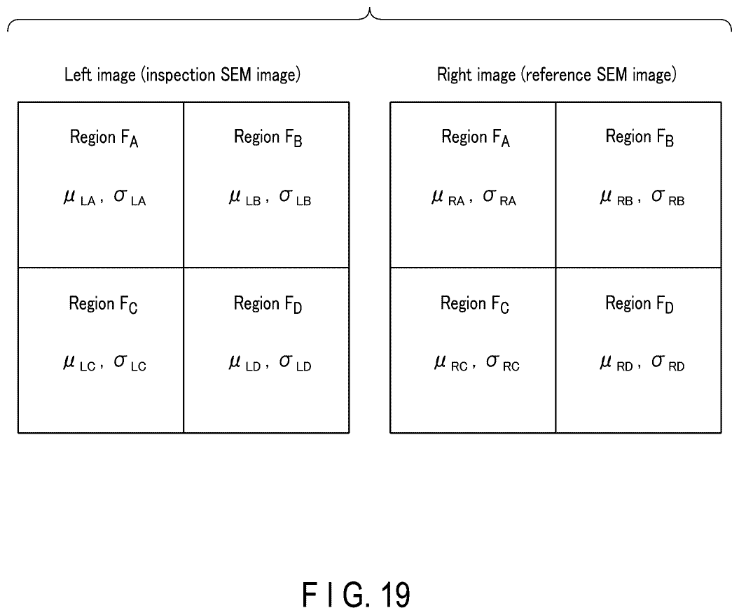

Referring to FIG. 19, a specific example of the case where an SEM image is divided into a plurality of regions will be described. FIG. 19 is a diagram showing an example in which each of an inspection SEM image and a reference SEM image is divided into four regions.

As shown in FIG. 19, each of the Left image and the Right image is divided into four regions (a region F_{A}, a region F_{B}, a region F_{C}, and a region F_{D}). The region F_{A} of the Left image corresponds to the region F_{A} of the Right image. It is assumed herein that a mean and a standard deviation of gradation values in the region FA of the Left image is μ_{LA} and σ_{LA}, respectively. Similarly, it is assumed that a mean and a standard deviation of gradation values in the region F_{A} of the Right image are μ_{RA} and σ_{RA}, respectively. In this case, a reference area threshold Z_{RA} in the region F_{A} of the Right image is calculated using the Formula (8).

$$\begin{matrix}[ Formula 8 ] & \\ {Z}_{R A} = {Z}_{L} ( {σ}_{RA} / {σ}_{LA} ) + {μ}_{RA} - {μ}_{LA} ( {σ}_{RA} / {σ}_{LA} ) & ( 8 )\end{matrix}$$

Similarly, the region F_{B} of the Left image corresponds to the region F_{B} of the Right image. It is assumed that a mean and a standard deviation of gradation values in the region F_{B} of the Left image are μ_{LB} and σ_{LB}, respectively. It is also assumed that a mean and a standard deviation of gradation values in the region F_{B} of the Right image are μ_{RB} and σ_{RB}, respectively. In this case, a reference area threshold Z_{RB} in the region F_{B} of the Right image is calculated using the Formula (9).

$$\begin{matrix}[ Formula 9 ] & \\ {Z}_{RB} = {Z}_{L} ( {σ}_{RB} / {σ}_{LB} ) + {μ}_{RB} - {μ}_{LB} ( {σ}_{RB} / {σ}_{LB} ) & ( 9 )\end{matrix}$$

The region F_{C} of the Left image corresponds to the region F_{C} of the Right image. It is assumed that a mean and a standard deviation of gradation values in the region F_{C} of the Left image are μ_{LC} and σ_{LC}, respectively. It is also assumed that a mean and a standard deviation of gradation values in the region Fc of the Right image are μ_{RC} and σ_{RC}, respectively. In this case, a reference area threshold Z_{RC} in the region F_{C} of the Right image is calculated using the Formula (10).

$$\begin{matrix}[ Formula 10 ] & \\ {Z}_{RC} = {Z}_{L} ( {σ}_{RC} / {σ}_{LC} ) + {μ}_{RC} - {μ}_{LC} ( {σ}_{RC} / {σ}_{LC} ) & ( 10 )\end{matrix}$$

Also, the region F_{D} of the Left image corresponds to the region F_{D} of the Right image. It is assumed that a mean and a standard deviation of gradation values in the region F_{D} of the Left image are μ_{LD} and σ_{LD}, respectively. It is also assumed that a mean and a standard deviation of gradation values in the region F_{D} of the Right image are μ_{RD} and σ_{RD}, respectively. In this case, a reference area threshold Z_{RD} in the region F_{D} of the Right image is calculated using the Formula (11).

$$\begin{matrix}[ Formula 11 ] & \\ {Z}_{RD} = {Z}_{L} ( {σ}_{RD} / {σ}_{LD} ) + {μ}_{RD} - {μ}_{LD} ( {σ}_{RD} / {σ}_{LD} ) & ( 11 )\end{matrix}$$

### [Step S406]

The area image generation circuit 303 computes an area of an area pixel (also referred to as an “inspection area pixel” hereinafter) from the inspection SEM image using the inspection area threshold Z_{L}, in a manner similar to step S104 in FIG. 5 of the first embodiment. At this time, the area image generation circuit 303 may execute the first filtering process and the second filtering process. The area image generation circuit 303 generates an inspection area image by repeating computation of the area of the area pixel, while shifting the SEM pixels one by one.

### [Step S407]

The area image generation circuit 303 computes an area of an area pixel (also referred to as a “reference area pixel” hereinafter) from the reference SEM image using the reference area threshold Z_{R} (or Z_{RA} to Z_{RD}), in a manner similar to step S406. At this time, the area image generation circuit 303 may execute the first filtering process and the second filtering process. The area image generation circuit 303 generates a reference area image by repeating computation of the area of the area pixel, while shifting the SEM pixels one by one. Steps S406 and S407 may be executed simultaneously or in a reverse order.

### [Step S408]

The contour point calculation circuit 304 calculates contour points from the area image using a Sobel filter, in a manner similar to step S105 in FIG. 5 of the first embodiment. The contour point calculation circuit 304 calculates contour points for each of the inspection area image and the reference area image.

### [Step S409]

The proximity contour point removal circuit 305 removes a proximity contour point from each of the inspection area image and the reference area image, in a manner similar to step S106 in FIG. 5 of the first embodiment.

### [Step S410]

The contour extraction circuit 214 generates a contour line joining contour points for each of the inspection area image and the reference area image, in a manner similar to step S107 in FIG. 5 of the first embodiment. Thereby, an inspection image and a reference image are generated. The contour extraction circuit 214 transmits the inspection image and the reference image to the comparison circuit 215.

### 3.3. Advantageous Effects of Present Embodiment

With the configuration of the present embodiment, it is possible to obtain advantageous effects similar to those of the first embodiment.

With the configuration of the present embodiment, it is possible to perform contour extraction even in the case where a D-D mode is adopted as the defect inspection mode.

Moreover, with the configuration of the present embodiment, it is possible to set different area thresholds for the respective regions (frames) into which an image is divided. It is thereby possible to correct uneven brightness between the dies, namely, between the inspection SEM image and the reference SEM image.

Note that the present embodiment is also applicable to a D-DB mode, in which an SEM image is imitated from design data and a reference image is generated.

### 4. Fourth Embodiment

Next, a fourth embodiment will be described. In the fourth embodiment, a case will be described where the second embodiment is applied to a D-D mode. Hereinafter, matters different from those of the first to third embodiments will be mainly described.

### 4.1. Details of Area Image Generation Process and Contour Data Generation Process

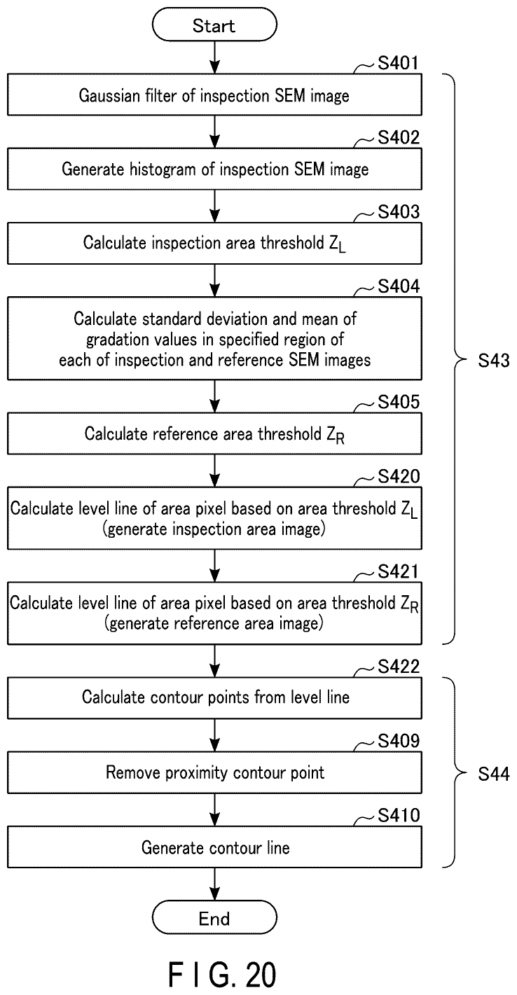

Referring to FIG. 20, details of the area image generation process at step S43 described with reference to FIG. 17 and the contour data generation process at step S44 will be described. FIG. 20 is a flowchart of an area image generation process and a contour data generation process.

As shown in FIG. 20, processing at steps S401 to S405, S420, and S421 is executed as the area image generation process (step S43). Then, steps S422, S409, and S410 are executed in sequence as the contour data generation process (step S44). Each of the steps S401 to S405, S409, and S410 is similar to that in FIG. 18 of the third embodiment.

### [Step S420]

After calculation of the reference area threshold Z_{R} has ended at step S405, the area image generation circuit 303 calculates a level line of the inspection area pixel using the inspection area threshold Z_{L}, in a manner similar to step S110 in FIG. 15 of the second embodiment. That is, in the present embodiment, the area computation of the area pixel is omitted.

### [Step S421]

The area image generation circuit 303 computes a level line of the reference area pixel using the reference area threshold Z_{R} (or Z_{RA} to Z_{RD}), in a manner similar to step S420. Steps S420 and S421 may be executed simultaneously or in a reverse order.

### [Step S422]

After calculation of the level line of the reference area pixel has ended at step S421, the contour point calculation circuit 304 calculates contour points of each of the inspection area image and the reference area image from the level line of the area pixel, in a manner similar to step S111 in FIG. 15 of the second embodiment.

### 4.2. Advantageous Effects of Present Embodiment

With the configuration of the present embodiment, it is possible to obtain advantageous effects similar to those of the second and third embodiments.

Note that the present embodiment is also applicable to a D-DB mode, in which an SEM image is imitated from design data and a reference image is generated, similarly to the third embodiment.

### 5. Modifications, Etc.

In the above-described embodiment, a case has been described where an inspection image is generated in an inspection apparatus; however, it is not limited to the inspection apparatus that the inspection image generation method is applicable to. The inspection image generation method may be applied to an apparatus for generating an inspection image based on image data, such as a measurement apparatus, or other apparatuses.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An inspection apparatus, comprising:
an image capturing mechanism configured to capture a first image of a wafer or a mask;
a first circuit configured to calculate a first threshold based on a plurality of gradation values of the first image;
a second circuit configured to generate a first line based on one-dimension function using the first threshold in a second pixel provided in a matrix of n×m first pixels with n rows and m columns included in the first image, where n and m are integers of two or greater;
a third circuit configured to calculate a first point in the second pixel by using the first line; and
a comparison circuit configured to compare a reference image with an inspection image that is based on the first point.

2. The inspection apparatus according to claim 1, wherein
the second circuit is further configured to calculate a first area of a portion of the second pixel enclosed by the first line and having a value equal to or greater than the first threshold, and
the third circuit is further configured to:
calculate a first normal vector of the second pixel using a Sobel filter;
form, in the second pixel, a first half-plane orthogonal to the first normal vector and having an area equal to the first area of the second pixel; and
calculate a midpoint of a segment forming the first half-plane of the second pixel as the first point.

3. The inspection apparatus according to claim 1, wherein
the third circuit is further configured to set a midpoint of the first line of the second pixel as the first point.

4. The inspection apparatus according to claim 1, wherein
the first circuit is further configured to:
generate a histogram of the plurality of gradation values of the first image;
determine, using the histogram, a maximum gradation value and a minimum gradation value each having a number of pixels equal to or greater than a second threshold from the plurality of gradation values; and
calculate the first threshold using the minimum gradation value and the maximum gradation value.

5. The inspection apparatus according to claim 1, wherein
the image capturing mechanism is further configured to capture a second image of the wafer or the mask to be compared with the first image,
the first circuit is further configured to calculate a second threshold of the second image using the first threshold,
the second circuit is further configured to generate a second line based on a predetermined function using the second threshold in a fourth pixel provided in a matrix of n×m third pixels with n rows and m columns included in the second image,
the third circuit is further configured to calculate a second point in the fourth pixel by using the second line, and
the comparison circuit is further configured to compare the inspection image with the reference image that is based on the second point.

6. The inspection apparatus according to claim 5, wherein
the second circuit is further configured to:
calculate a first area of a portion of the second pixel enclosed by the first line and having a value equal to or greater than the first threshold; and
calculate a second area of a portion of the fourth pixel enclosed by the second line and having a value equal to or greater than the second threshold, and
the third circuit is further configured to:
calculate a first normal vector of the second pixel and a second normal vector of the fourth pixel using a Sobel filter;
form, in the second pixel, a first half-plane orthogonal to the first normal vector and having an area equal to the first area of the second pixel;
calculate a midpoint of a segment forming the first half-plane of the second pixel as the first point;
form, in the fourth pixel, a second half-plane orthogonal to the second normal vector and having an area equal to the second area of the fourth pixel; and
calculate a midpoint of a segment forming the second half-plane of the fourth pixel as the second point.

7. The inspection apparatus according to claim 5, wherein
the third circuit is further configured to:
set a midpoint of the first line of the second pixel as the first point; and
set a midpoint of the second line of the fourth pixel as the second point.

8. A inspection method, comprising:
capturing a first image of a wafer or a mask;
calculating a first threshold based on a plurality of gradation values of the first image;
generating a first line based on a predetermined function using the first threshold in a second pixel provided in a matrix of n×m first pixels with n rows and m columns included in the first image, where n and m are integers of two or greater;
calculating a first point in the second pixel by using the first line; and
comparing a reference image with an inspection image that is based on the first point.

9. The inspection method according to claim 8, further comprising:
calculating a first area of a portion of the second pixel enclosed by the first line and having a value equal to or greater than the first threshold, wherein
the calculating the first point includes:
calculating a normal vector in the second pixel using a Sobel filter;
forming, in the second pixel, a first half-plane orthogonal to the first normal vector and having an area equal to the first area of the second pixel; and
calculating a midpoint of a segment forming the first half-plane of the second pixel as the first point.

10. The inspection method according to claim 8, further comprising:
setting a midpoint of the first line of the second pixel as the first point.

11. The inspection method according to claim 8, wherein
the calculating the first threshold includes:
generating a histogram of the plurality of gradation values of the first image;
determining a maximum gradation value and a minimum gradation value each having a number of pixels equal to or greater than a second threshold from the plurality of gradation values using the histogram; and
calculating the first threshold using the minimum gradation value and the maximum gradation value.

12. The inspection method according to claim 8, further comprising:
capturing a second image of the wafer or the mask to be compared with the first image;
calculating a second threshold of the second image using the first threshold;
generating a second line based on a predetermined function using the second threshold in a fourth pixel provided in a matrix of n×m third pixels with n rows and m columns included in the second image; and
calculating a second point in the fourth pixel by using the generated second line, wherein
the inspection image is compared with the reference image that is based on the second point in the comparing.

13. The inspection method according to claim 12, further comprising:
calculating a first area of a portion of the second pixel enclosed by the first line and having a value equal to or greater than the first threshold; and
calculating a second area of a portion of the fourth pixel enclosed by the second line and having a value equal to or greater than the second threshold, wherein
the calculating the first point includes:
calculating a first normal vector of the second pixel using a Sobel filter;
forming, in the second pixel, a first half-plane orthogonal to a first normal vector and having an area equal to the first area of the second pixel; and
calculating a midpoint of a segment forming the first half-plane of the second pixel as the first point, and
the calculating the second point includes:
calculating a second area of a portion of the fourth pixel enclosed by the second line and having a value equal to or greater than the second threshold;
forming, in the fourth pixel, a second half-plane orthogonal to the second normal vector and having an area equal to the second area of the fourth pixel using the Sobel filter; and
calculating a midpoint of a segment forming the second half-plane of the fourth pixel as the second point.

14. The inspection method according to claim 12, further comprising:
setting a midpoint of the first line of the second pixel as the first point; and
setting a midpoint of the second line of the fourth pixel as the second point.
